(19) United States
(12) Patent Application Publication
(10) Pub. No.: US 2008/0127537 A1
(43) Pub. Date: Jun. 5, 2008

(54) EQUIPMENT COMPRISING A DISPLAY UNIT INCLUDING A TRANSPARENT FILM FIXED ON A RIGID PERFORATED PLATE, AND A METHOD OF FABRICATING SAID EQUIPMENT

(76) Inventor: Christian Boisseau, Mettray (FR)

Correspondence Address: LEFFERT JAY & POLGLAZE, P.A., P.O. BOX 581009, MINNEAPOLIS, MN, 55458-1009, US

(21) Appl. No.: 11/923,162

(22) Filed: Oct. 24, 2007

(30) Foreign Application Priority Data
Oct. 25, 2006 (FR) 0654501

(51) Int. Cl. G09F 13/06

(52) U.S. Cl. 40/579

(57) ABSTRACT

Equipment comprises a display unit mounted in a casing and includes a support plate, light sources being fixed to the front side of the support plate, a rigid plate being mounted in front of the support plate and aligned with the light sources, orifices being arranged therein to allow the passage of light emitted by the light sources, and a substantially transparent thin film of thickness lying in the range 200 μm to 1 mm being fixed to the front side of said rigid plate. A method of producing said equipment comprises a step of applying an adhesive film to the rigid plate, a step of cutting the rigid plate which is thus coated with adhesive, and a step of bonding said transparent thin film to the rigid plate which has been perforated and coated with said adhesive.

### RELATED APPLICATION

This application claims priority to French Patent Application No. 0654501, filed Oct. 25, 2006, which application is assigned to the assignee of the present invention and the entire contents of which are incorporated herein by reference.

### TECHNICAL FIELD

The present invention relates to the field of displaying messages using equipment integrating a display unit including light sources. Such equipment may, for example, be a display panel, more particularly a panel used to display alphanumeric characters or graphical elements, such as display panels on road and highway networks.

The intention of a display is that the reader will notice it; in the following, the “front” or “display” direction denotes the direction directed from the display to the reader, while the “back” direction denotes the opposite direction.

### BACKGROUND OF THE INVENTION

In a known embodiment, such equipment may include a display unit integrated in a casing and comprising:
a support plate fixed to the back of the casing;
light sources fixed to the front of that support plate, which are generally point sources and in particular light emitting diodes (LEDs);
a thick transparent plate of plastics material that is 3 mm [millimeters] to 10 mm thick, disposed in front of the light sources at the front face of the display; and
a black adhesive film adhesively bonded to said transparent plate, and including holes aligned with the light sources to allow the emitted light to pass through.

The thick transparent plate protects the light sources from precipitation, spatters, and the like, and supports the black adhesive film. It also provides a weather-resistant seal.

The transparent plate is normally made of PMMA (polymethylmethacrylate) or polycarbonate.

That structure suffers from a number of disadvantages.

Firstly, when the front face is constituted by a transparent plate, if the support plate were to be fixed to the front plate by piercing holes into that plate, problems would arise as regards sealing. For that reason, the support plates are not fixed to the front face of the casing but to the back of the casing.

However, when used outdoors, the temperature variations that affect the display unit can be quite considerable in amplitude; in France, for example, the temperature may vary from −30° C. to more than 100° C. Because of those changes in temperature and because of the thermal expansion of the materials, the dimensions of the display unit vary considerably. If the thermal expansion coefficients of the casing and of the front face transparent differ, then under extremes of temperature, the orifices for passing light through the transparent plate may be offset from the light sources, clearly rendering the display defective. Further, such dimensional variation differences between the transparent plate and the casing create problems with sealing at the junction between the plate and the casing; finally, if the transparent plate is held tightly and there is a constraint on its expansion, it may buckle, to the detriment of the external appearance of the equipment.

Because of the above problems, the dimensions of the display unit must usually be limited.

In another known embodiment, a signaling equipment may comprise a display unit which comprises:
a support plate located at the back of the display unit;
a set of light sources fixed to the front of said support plate, which sources are generally LEDs;
a rigid plate including holes aligned with the light sources, disposed in front of the light sources in the front face of the display unit; and
transparent plugs or light guides made of plastics material and fixed in said holes in front of the light sources to allow the emitted light to pass through.

Such a structure suffers from problems with sealing the plugs. Because of their large number, it is difficult to guarantee a perfect weather seal for all of them. Further, because of the number of small parts and the labor required to assemble it, such a structure is expensive.

### SUMMARY OF THE INVENTION

A first object of the invention is to overcome the above-mentioned disadvantages by defining an equipment comprising a display unit mounted in a casing and including at least one support plate and light sources fixed to the front side of the support plate, to produce equipment that is simple and cheap to manufacture, wherein the display unit can have large dimensions and present good weather-proofing.

This object is achieved by the fact that said display unit also comprises a rigid plate mounted in front of the support plate and light sources, orifices provided therein allowing light emitted by the light sources to pass through, and a substantially transparent thin film fixed on said rigid plate.

Said thin film may, for example, be a film of plastics material adhesively bonded to the rigid plate. Said film allows light to pass and allows the display unit to carry out its function while providing sealing and protecting it against precipitation, spatters, and the like. It may be transparent, or translucent, or it may carry a screen or a pattern depending on the desired visual effect.

In a first implementation of the invention, said thin film is fixed to the front face of the rigid plate. The back of the rigid plate is then clear, and thus the support plates may be fixed directly to the back of the rigid plate.

In a second implementation of the invention, the thin film is fixed to the back of the rigid plate; the support plate is thus fixed towards the sides or the back of the equipment, for example on the base of the casing or on another internal part of the casing and disposed behind the support plate.

Because the film is thin, expansion forces exerted by the rigid plate when the temperature rises or shrinking forces when the temperature drops are large compared with forces of the same nature exerted by the transparent thin film. In this situation, deformations linked to temperature variations are essentially imposed by the rigid plate on the transparent thin film rather than vice versa.

Furthermore, to reduce undesirable reflections which are reflected or transmitted by the transparent film towards an observer, it is possible to fix a light absorption structure on its front face. This may take a number of forms, for example a thin plate of anodized or black-painted aluminum, a black plastics film bonded to the transparent film, a layer of black paint, etc. Thus, when looking at the signaling equipment, an observer is not disturbed by the neutral surfaces of the panel (i.e. surfaces other than those transmitting light from the light sources); further, a contrast is created between the neutral surfaces and the surfaces transmitting light from the light sources, so that the transmitted message can be perceived with minimal risk of error.

To overcome the above-mentioned disadvantages, the invention also aims to define a method of simply and economically manufacturing equipment including a display unit, said display unit possibly having large dimensions, and being properly weather-proof.

This and other aims are achieved by a method comprising the following steps:
providing a support plate comprising a set of light sources fixed on the front of said support plate;
providing a rigid plate and an adhesive;
depositing a film of said adhesive on one face of the rigid plate;
cutting orifices through said plate and adhesive film, the disposition of the orifices being selected as a function of the disposition of the light sources on the support plate, to ensure that light emitted by the light sources passes through once the display unit has been assembled;
providing a substantially transparent thin film of thickness lying in the range 200 μm [micrometers] to 1 mm;
fixing said thin film to the rigid plate using adhesive bonding;
providing the other elements necessary for producing the equipment, in particular those for a casing to mount the display unit;
assembling said rigid plate and film in the casing with the other elements of the display unit, allowing for the position of the light sources, to constitute the display unit in the equipment.

This method corresponds to the particular circumstance in which the thin film is fixed on the rigid plate, advantageously by adhesive bonding.

### BRIEF DESCRIPTION OF THE DRAWINGS

The invention can be better understood and its advantages become more apparent from the detailed description given below of embodiments of non-limiting examples. The description refers to the accompanying drawings in which:

FIG. 1 is a perspective view of a display panel of the invention comprising a display unit;

FIG. 2 is a sectional view of said panel in a first embodiment of the invention;

FIG. 3a is a sectional view of a detail of the preceding panel showing the structure of the display unit in accordance with a first embodiment of the invention;

FIG. 3b is a detailed sectional view of the preceding panel showing the structure of the display unit in accordance with a second embodiment of the invention.

### DETAILED DESCRIPTION OF THE PREFERRED EMBODIMENTS

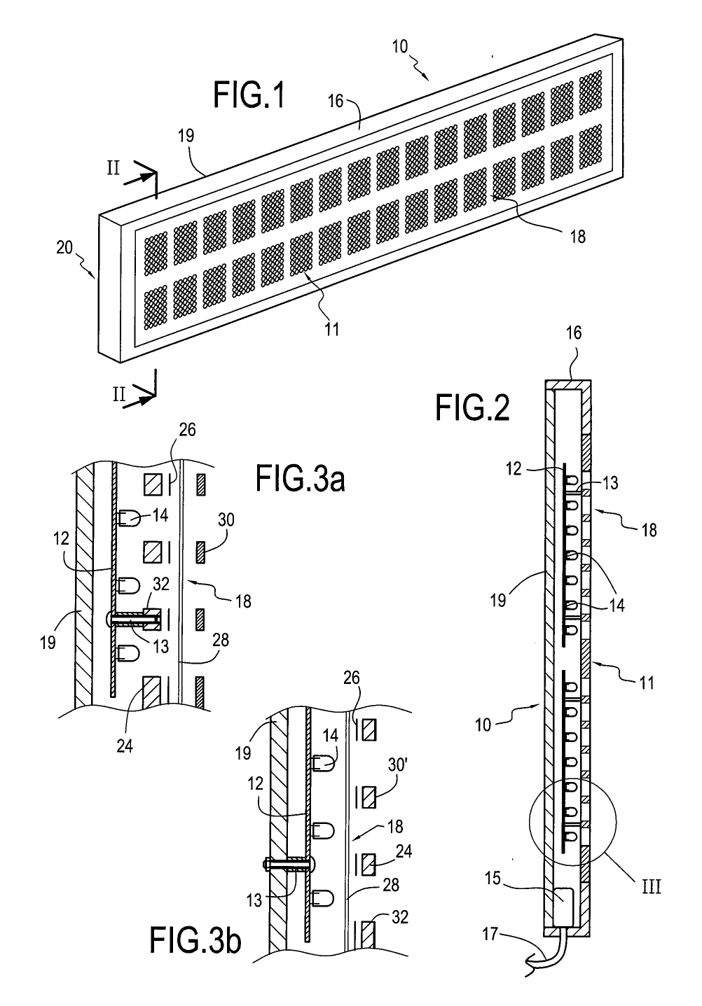

With reference to FIGS. 1 and 2, equipment comprising a display unit—in fact a display panel—of the invention is described below.

The panel 10 includes a casing 20, electrical means 15, connection cables 17, and a display unit 11 which in the example shown occupies the whole of the front surface.

In general, the casing 20 is metallic and mechanically protects and holds the display unit 11. In the example shown, the casing 20 comprises a panel base 19 constituting its rear face and a frame 16 constituting its periphery; its front face is occupied by the front elevation or façade 18 of the display unit 11.

Said façade 18 is fixed to the casing in sealed manner inside the frame 16. The casing 20 and the façade 18 must ensure that the inside of the panel is protected against bad weather. Their parts are thus arranged to ensure that the inside of the casing is sealed, with the exception of certain passages provided to allow ventilation of the inside of the panel and to allow cables to pass through.

Inside the panel, the display unit 11 includes support plates 12 and light sources 14; they are generally LEDs. In general, there may be one or more support plates; as an example, one support plate may be provided per display zone of the display unit 11. Said plates support the light sources and can fix them and hold them in position, and can also include their electric power supply circuits. These plates are connected to electrical means 15 from which they draw their power supply.

In particular the electrical means 15 can modulate the illumination to ensure that the light sources display the desired message. They are connected using connection cables 17.

The front façade 18 is the display section of the display unit. It includes transparent portions, the structure of which is described below, through which the light sources can be seen to discern the displayed message.

In the embodiment shown, the equipment is a panel 10 which comprises a single display unit that occupies the whole of the front surface. Naturally, the equipment of the invention can more generally include other signaling elements and/or a plurality of display units.

Referring to FIGS. 3a and 3b, there follows a description of a display unit 11 of the equipment of the invention and in particular of the structure of its façade 18. Said display unit includes one or more support plates 12, a set of light sources 14 fixed to said support plates, and its façade 18. Said façade, positioned in front of the support plates 12 and light sources 14, includes a rigid plate 24 with orifices 32 being provided therein to allow light emitted by the light sources to pass through, and a substantially transparent thin film 28 fixed to said rigid plate 24.

In a first embodiment (FIG. 3a), the thin film is fixed in front of the rigid plate. In this case, the support plates 12 may then be fixed either towards the sides or the back of the casing, or towards the front of the casing, i.e. on the rigid plate. In this last configuration, the risk of a problem with the seal is advantageously minimized. As an example, it may be fixed by spacers 13.

In a second embodiment, the thin film is fixed to the back of the rigid plate. It is then necessary to avoid fixing the support plates towards the front through the thin film, since it would then lose its imperviousness. For this reason, the plates are fixed towards the back or towards the sides of the equipment, for example, as shown in FIG. 3b, to the base of the panel or on another internal part of the panel. Fixing can be ensured via spacers 13.

Advantageously, the rigid plate 24 and the casing 20 have substantially equal thermal expansion coefficients. Thus, during temperature variations, their dimensional variations are similar. Thus, the façade 18 does not deform nor does it buckle and no problems arise concerning sealing. For this reason, it is possible to produce display units 11 with large dimensions.

Advantageously, the rigid plate 24 is a metal plate. It benefits from being strong, with reduced weight and thickness.

Advantageously, it is made of aluminum. Aluminum is advantageous for its corrosion resistance, its low density, and its ease of machining.

The thickness of the thin film 28 may be in the range 200 μm up to 1 mm; for thicknesses of close to 1 mm, then it is more like a thin plate. The film may be made of plastics material such as PMMA or polycarbonate or, more generally, any substantially transparent or translucent material.

Advantageously, the thickness of the thin film 28 may be in the range 200 μm to 500 μm, more generally thinner than the rigid plate.

Advantageously, the thin film 28 is fixed by adhesive bonding, for example using an adhesive film 26 on the rigid plate 24.

Further, a light absorption structure may be fixed on the front face of the display unit. As already stated, this is intended to reduce unwanted light reflected towards an observer to as low a level as possible. To absorb light, this structure is generally matt or dark, in particular black.

A first embodiment for the light absorption structure consists of a layer of paint applied directly to the front of the display unit, but without blocking the holes for passing light. This application may be produced by a surface treatment, for example by screen printing, pad printing, spraying, or the like, depending on the material.

A second implementation for producing the light absorption structure consists in using an attached plate (possibly a film) that is perforated and made of plastics or metallic material (reference 30 of FIG. 3a). If the plate is metallic, it may, for example, be made of aluminum; the black color may then be produced by anodizing or painting. With a plastics plate (or a plastics film), the black color may be obtained by mass coloration. The light absorption structure is thus fixed to the front face of the display unit, for example by adhesive bonding.

In the particular circumstance in which said rigid plate of the display unit façade is placed in front of the transparent film, then advantageously said rigid plate may coincide with the light absorption structure; the two elements are thus simply constituted by one and the same part (reference 30′) in FIG. 3b.

Finally, the invention defines a preferred method of fabricating equipment 10 including a display unit 11. Said method is characterized in that it comprises the following steps:
providing support plates 12 comprising a set of light sources 14 fixed to their front faces;
providing a rigid plate 24 and an adhesive 26;
depositing a film of said adhesive on one face of the rigid plate;
cutting orifices 32 through said plate and adhesive film, the disposition of the orifices being selected as a function of the disposition of the light sources on the support plate, to ensure that light emitted by the light sources passes through once the display unit has been assembled;
providing a substantially transparent thin film 28 of thickness lying in the range 200 μm to 1 mm;
fixing said thin film to the rigid plate using adhesive bonding;
providing the other elements necessary for producing the equipment, in particular those for a casing to mount the display unit;
and assembling said rigid plate 24 and film 28 in the casing 20 with the other elements of the display unit, while taking into account the position of the light sources 14, to constitute the display unit 11 in the equipment 10.

The method presented herein is remarkably simple and inexpensive because of the small number of production steps and parts employed.

Finally, the skilled person will note that the present invention is not applicable solely to light sources being direct light sources, as they are with LEDs, but also to light sources that are devices for redirecting light, the light itself being produced by an offset source or set of sources.

1. Equipment comprising a display unit including a support plate and light sources fixed to the front of said support plate, a casing in which the display unit is mounted, wherein said display unit further comprises a rigid plate mounted in front of the support plate and the light sources, orifices being provided therein to allow the passage of light emitted by the light sources; and a substantially transparent thin film of thickness that is in the range 200 μm to 1 mm, fixed to said rigid plate.

2. Equipment according to claim 1, wherein the thin film is fixed to the front of said rigid plate.

3. Equipment according to claim 2, wherein the support plate is fixed to the rigid plate.

4. Equipment according to claim 1, wherein the thin film is fixed to the back of said rigid plate.

5. Equipment according to claim 4, wherein the support plate is fixed towards the sides or back of the equipment.

6. Equipment according to claim 1, wherein the rigid plate and the casing have substantially equal thermal expansion coefficients.

7. Equipment according to claim 1, wherein the thickness of said film (28) is in the range 200 μm to 500 μm.

8. Equipment according to claim 1, wherein the film is thinner than the rigid plate.

9. Equipment according to claim 1, wherein said film is adhesively bonded to said rigid plate.

10. Equipment according to claim 1, wherein the equipment further includes a light absorption structure fixed to the front face of the display unit.

11. Equipment according to claim 10, wherein said light absorption structure includes a metal plate.

12. Equipment according to claim 10, wherein said light absorption structure and the rigid plate are formed by one and the same part.

13. Equipment according to claim 10, wherein said light absorption structure comprises a film or plate of plastics material.

14. Equipment according to claim 10, wherein said light absorption structure comprises a black or dark surface treatment.

15. Equipment according to claim 10, wherein said light absorption structure is fixed by adhesive bonding.

16. A method of fabricating equipment comprising a display unit, wherein it comprises the steps of:
providing a support plate comprising a set of light sources fixed on the front of said support plate;
providing a rigid plate and an adhesive;
depositing a film of adhesive on the front face of the rigid plate;
cutting orifices through said plate and adhesive film, the disposition of the orifices being selected as a function of the disposition of light sources on the support plate, to ensure that light emitted by the light sources passes through once the display unit has been assembled;
providing a substantially transparent thin film of thickness lying in the range 200 μm to 1 mm;
fixing said thin film to the rigid plate using adhesive bonding;
providing the other elements necessary for producing the equipment, in particular those for a casing to mount the display unit;
assembling said rigid plate and film in the casing with the other elements of the display unit, while taking into account the position of the light sources, to constitute the display unit in the equipment.

17. A method of fabricating equipment including a display unit according to claim 16, further comprising a step of fixing a light absorption structure to the front face of said display unit.
